(19) United States
(12) Patent Application Publication
(10) Pub. No.: US 2009/0259606 A1
(43) Pub. Date: Oct. 15, 2009

(54) DIVERSIFIED, SELF-ORGANIZING MAP SYSTEM AND METHOD

(76) Inventor: Vincent Pei-wen SEAH, Miami Beach, FL (US)

Correspondence Address: LEIGHTON K. CHONG;PATENT ATTORNEY, 133 KAAI STREET, HONOLULU, HI, 96821, US

(21) Appl. No.: 12/421,045

(22) Filed: Apr. 9, 2009

Related U.S. Application Data
(60) Provisional application No. 61/044,247, filed on Apr. 11, 2008.

(51) Int. Cl. G06F 15/18; G06F 15/16; G06F 17/30

(52) U.S. Cl. 706/16; 709/204; 707/E17.032

(57) ABSTRACT

A diversified, self-organizing map (SOM) system and method creates a number of special-purpose SOMs by filtering and training from a SOM Database which contains user preference data entries that include a wide range of fields or attributes of user preferences. Each special-purpose SOM is trained with a filtered subset of user preference data for fields and attributes related to its special purpose. Two or more special-purpose SOMs are harnessed inter-cooperatively together to provide recommendations of preferred items in response to queries. Multiple SOMs can be maintained at different websites and harnessed together through a global SOM interface. The system can function more efficiently than a single large SOM using a monolithic database with single-type data entries of large dimensionality.

This U.S. patent application claims the priority of U.S. Provisional Application 61/044,247, filed on Apr. 11, 2008, by the same inventor, entitled Diversified Multi-SOM System and Method.

### TECHNICAL FIELD

This invention generally relates to methods and systems for making recommendations of related items or affinities in response to a search query using Self-Organizing-Maps (SOMs).

### BACKGROUND OF INVENTION

It is well known to use various types of statistical clustering methods, and specifically those based on Self Organizing Maps (SOMs), to topographically organize data about users in order to recommend related items or affinities in response to a search query. The Finnish professor Tuevo Kohonen is generally credited with developing the field of self-organizing maps. A SOM is derived from an initial set of nodes which are trained with a dataset of training objects that are weighted by their spatial distance from the training nodes. As each training object is positioned relative to its proximate nodes, the distance relationships of the nodes from each other and the training objects to the nodes are recalculated (updated). As training progresses, a topographical mapping of objects clustered around proximate nodes emerges. The objects can also be defined by other weighting parameters that can be represented visually (shade, color, height) for depth-wise interpretation of the map. For example, differential colors can be used to visually represent the differential weighting of objects around nodes. The clustering of similar objects by color can reveal visual pattern relationships not otherwise discernible on the data level.

For example, the prior art has disclosed various types of SOM-based systems for organizing songs in a database by relatedness of genre, sound, theme, and/or user-preference, as referenced in articles such as: “Self Organizing Maps for Content-Based Music Clustering”, by M. Fruhwirth, A. Rauber, Dept. of Software Technology, Vienna University of Technology, 2001; “A Music Retrieval System Based on User-Driven Similarity And Its Evaluation”, by F. Vignoli, S. Pauws, published in International Symposium On Music Info Retrieval (ISMIR) 2005, pp. 272-279; “PlaySOM and PocketSOMplayer, Alternative Interfaces to Large Music Collections”, Dept. of Software Technology, Vienna University of Technology, 2005; “Visual Playlist Generation on the Artist Map”, Institute of Information and Computing Sciences, Utrecht University, 2005; “Learning a Gaussian Process Prior for Automatically Generating Music Playlists”, Microsoft Corporation; “Databionic Visualization of Music Collections According to Perceptual Distance”, Data Bionics Research Group, Philipps-University Marburg; “Learning User Preferences for Sets of Objects”, Computer Science and Electrical Engineering Department, University of Maryland Baltimore County; “XPOD: A Human Activity Aware Learning Mobile Music Player”, Computer Science and Electrical Engineering Department, University of Maryland, Baltimore County; “Music Retrieval System Based on User-Driven Similarity and Its Evaluation”, Philips Research Laboratories; “Automatic Generation of Social Tags for Music Recommendation”, Sun Labs, Sun Microsystems; “One-Touch Access to Music on Mobile Devices”, Department of Computational Perception, Johannes Kepler University Linz, Austria; “An Innovative Three-Dimensional User Interface for Exploring Music Collections Enriched with Meta-Information from the Web”, Department of Computational Perception, Johannes Kepler University Linz, Austria; “Automatic Characterization of Music Complexity: A Multi-Faceted Approach”, Universitat Pompeu Fabra, Barcelona; “MusicTable: A Map-Based Ubiquitous System for Social Interaction with a Digital Music Collection, Dept. of Computer Science, University of British Columbia; “Musicream: New Music Playback Interface for Streaming, Sticking, Sorting, and Recalling Musical Pieces”, National Institute of Advanced Industrial Science and Technology (AIST).

In U.S. Published Patent Application 2003/0037036, a system for automatically classifying data according to perceptual properties of the data forms a classification chain for searching and sorting of large databases of media entities. In one example, the classification chain embodies a canonical set of rules for classifying music and/or songs. Playlists may be generated from a single song and/or a user preference profile. Nearest neighbor matching algorithms may be utilized to locate songs that are similar to the single song and/or user profile.

In U.S. Published Patent Application 2004/0254957, a SOM-based system is used to model user preferences as data entities presented as vectors and clustered into categories. The model is updated on the basis of user feedback. The model may be exploited in music, for example, musical genres can be categories, and stylistic factors may be attributes. The SOM (Self-Organizing Map) is a preferred model that preserves the original topological relationships in the input space.

In U.S. Published Patent Application 2006/0026048, user preferences are mapped as a topography that depicts user ratings of products in a recommendation database. In making a recommendation of a potential product, the system determines the similarities of products that fall in the positive preference cluster with the potential product. In a music recommendation system, the input user preferences may include age, gender, occupation, genre, CD, and radio program preferences.

In U.S. Published Patent Application 2006/0254409, a system for sorting and searching media objects for playback on a player device (such as an MP3 player) stores information regarding media content previously played by a user, including playback frequency, determines similarity of new content to content previously played, scores new content based on the stored information, and sorts new content based on the scoring.

In U.S. Published Patent Application 2006/0101060, a system for managing and searching massive amounts of feature-rich data like SOM-based systems has a segmentation and feature extraction unit for segmenting object data into a plurality of data segments and generating a feature vector for each data segment. The feature vectors are converted into compact bit-vectors corresponding to the object. A similarity index is generated with bit-vectors corresponding to a plurality of objects. The system has a similarity ranking component for ranking objects by estimating their distances to a query object. For searching music content, audio features of a song may be extracted from short moving windows by using Short Time Fourier Transform Wavelets. Features can be computed at different time resolutions, and the value of each feature, along with the mean and variance of the features can be used as features themselves.

In U.S. Published Patent Application 2007/0220552, a media service enables automatic download of personalized media content to a portable media device based on user preferences. The system can evaluate content on a user's media device as well as user actions to infer user's preferences. The user can subscribe to playlists generated by the media service, another user's playlist(s), a simulated radio station, etc., and can receive content updates. For example, a user can provide information related to the user's music preferences (e.g., genre, artist, time period, . . . ) that is utilized by the music service to determine content that has a high likelihood of being pleasing to the user. Moreover, personalized content can be user-recommended, such that User A can receive automatic downloads of songs, albums, playlists, etc., that have been recommended by User B.

In U.S. Published Patent Application 2008/0010372, an online service can provide music content to handheld devices via a Wi-Fi or other wireless connection. Content and playlists may also be pushed based on predetermined rules, favorite preferences of users, and other criteria. Once a recommended list is generated, the user has the option to download the whole list or select and listen to any or all the songs on the list. In another example, a new user can join the online service by providing information about his/her music preferences. The server can use this information to generate a proposed playlist for the user. The recommendation engine may use Bayesian statistics, manually-created artist/genre/track associations, content-analytic techniques, and other methods.

However, the prior art has generally relied on SOM-based methods that utilize a large database storing data entries with a number of pre-specified data fields or attributes that are to be catalogued and mapped. This creates a problem that only homogenous data entries of like dimensionality can be used, thereby requiring such SOM databases to be built in a monolithic or captive manner. It would be desirable to create SOM-based systems that can utilize non-homogenous data of differing dimensionality and/or from diverse sources to provide recommender engines of greater flexibility and openness to wider universes of users.

### SUMMARY OF INVENTION

In the present invention, a number of special-purpose SOMs are created from a SOM Database which contains data entries that include a wide range of fields or attributes of user preferences. Each special-purpose SOM is created by filtering and training with a subset of data having fields and attributes related to its given special purpose. Two or more special-purpose SOMs can then be harnessed cooperatively together to provide recommendations in response to a wide range of types of user queries. Multiple SOMs can be maintained at different websites and harnessed together through a global SOM interface. The system can function more efficiently than a single large SOM using a monolithic database with single-type data entries of large dimensionality.

For example, users may register on an associated website to be included in the SOM Database by inputting user preferences that spans a wide range of preference fields and attributes, including geographical data, personal/social data (gender, birth date, sexual orientation, ethnicity, religion, education, income level, profession, smoke/drink/food and language preferences), personal interest data (friends, favorites, blogs, music genres), song preferences, band/artist preferences, etc. A special-purpose User-SOM can then be constructed with data entries filtered from the SOM Database for those having at least a specified set of limited data fields, such as “User Age/Gender Demographics” and “Song Preferences”. The User-SOM can then be queried for the specific purpose of locating song preferences for users of a certain age and gender.

Other special-purpose SOMs are also created from the data-diversified SOM Database for respectively defined other special-purpose queries. For example, a Song-SOM can be created that clusters similar song preferences according to a social group preference of users who preferred those songs, and therefore can be queried for a certain social group preference (e.g., “country folk”) to recommend songs preferred by that social group. Moreover, two or more special-purpose SOMs can be used together to obtain query responses that reflect an intersection of respective data fields.

Other objects, features, and advantages of the present invention will be explained in the following detailed description with reference to the appended drawings.

### BRIEF DESCRIPTION OF DRAWINGS

FIG. 1 illustrates the process for generating and utilizing two or more SOMs to provide recommendations in response to user queries.

FIG. 2 shows an example of a User-Song SOM recommending songs of similar users.

FIG. 3 shows an example of a front end interface for recommending similar users.

FIG. 4 shows an example of a flow chart for studying song artists strength.

FIG. 5 shows an example of a flow chart for studying artists strength and user demographic data.

FIG. 6 shows an example of a Song-User SOM for recommending other similar songs.

FIG. 7 shows an example of a front-end interface for recommending similar songs.

FIG. 8 shows an example Song-User SOM for identifying users preferring a given song.

FIG. 9 shows an example of a software agent structure for a single SOM.

FIG. 10 shows an example of using dual SOMs for User-Demography and User-Song.

FIG. 11 shows an example of using dual SOMs for User-Demography and Song-User.

FIG. 12 shows an example of a software agent structure for dual SOMs.

FIG. 13 shows an example of accessing five SOMs across five websites.

FIGS. 14 and 15 show an example flow chart for user interaction with multiple SOMs.

FIG. 16 shows an example of a software agent structure for multiple SOMs.

### DETAILED DESCRIPTION OF INVENTION

In the following detailed description, certain preferred embodiments are described as illustrations of the invention in a specific application, network, or computer environment in order to provide a thorough understanding of the present invention. Those methods, procedures, components, or functions which are commonly known to persons of ordinary skill in the field of the invention are not described in detail as not to unnecessarily obscure a concise description of the present invention. Certain specific embodiments or examples are given for purposes of illustration only, and it will be recognized by one skilled in the art that the present invention may be practiced in other analogous applications or environments and/or with other analogous or equivalent variations of the illustrative embodiments.

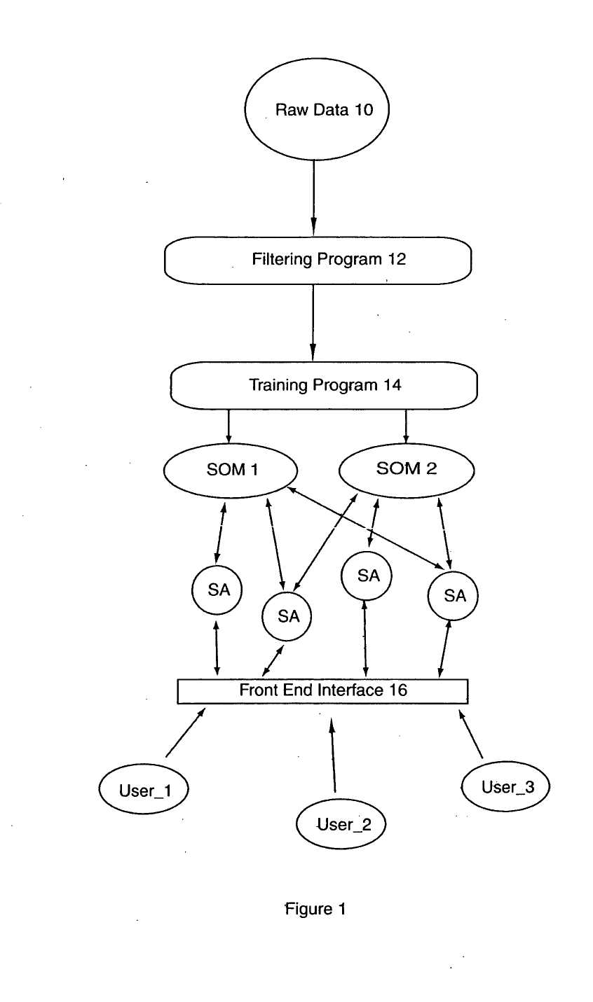

Referring to FIG. 1, a basic schematic framework for a data-diversified SOM-based system and method in accordance with the present invention is illustrated. Raw Data 10 is stored and maintained in a SOM Database comprising non-homogenous data entries having data fields or attributes out of a plurality of accepted data fields or attributes. When it is desired to create one or more special-purpose SOMs (named here as SOM 1 and SOM 2), a Filtering Program 12 is used to filter data entries having the data fields or attributes to be used in the special-purpose SOM(s), and a Training Program 14 is used to train initial constructs for the specific-purpose SOMs using data entries filtered from the database having the requisite data fields or attributes corresponding to those to be used by the special-purpose SOMs. A Front End Interface 16 is provided to enable users (User_1, User_2, User_3, etc.) to input queries to the multi-SOM system, either through direct interaction with the Front End Interface 16, or through an Application Program Interface, remote procedure calls or other remote invocation process supported by the Front End Interface 16. Software Agents SA are deployed by the Front End Interface 16 to interact between the queries received by the Front End Interface 16 and the SOMs. The SOM Database accepts data entries that include a wide range of different data fields or attributes of user preferences. The system can then utilize non-homogenous data of differing dimensionality and/or from diverse sources to construct a number of specific-purpose SOMs to handle diverse types of queries from users.

More specifically, in FIG. 1, the Raw Data 10 encompasses data entries for user profiles as demographic, psychographic, content and other vectors. The data entries may be gathered through user registration procedures on one or more websites. The demographic vector can include a wide range of factors, such as sex, age, education level, country, state, city. The psychographic vector can relate to a wide range of attributes of lifestyle, attitude and opinions. The content vector can include a wide range of content objects, such as friends, lists of songs, lists of videos or lists of favorite artists expressed as preferences by the user. Each user profile can include explicit or implicit users' data as gathered by the online services.

The user profile, uⱼ for user j, should be quantified as a 1×n profile vector, whose vector element values can be in binary ε[0,1], ordinal εZ and/or real numbers εR. The profile vector has four distinct sections:
uⱼ=└userID demoⱼ psyⱼ contentⱼ┘
   where userID represents the identification number of the user, demoⱼ represents the demographic vector, psyⱼ represents the psychographic vector and contentⱼ represents the content vector. The content vector can be further broken down into:
contentⱼ=└songsⱼ friendsⱼ videosⱼ . . . etcⱼ┘
   An example for a user profile vector is:
u₁₂₃=[123 245 40 10 1 0 0 . . . 1 0 9 0.8 1.5]

The filtering process involves extracting required data to train a SOM and improving the quality of the extracted data. The result is known as filtered data. The form of SOM to be trained determines the extraction process used. For example, if we need to build a User-Song SOM, then we will only extract the following for each user:
uⱼ=└userID songsⱼ┘.
   This vector essentially lists the userID and the list of songs associated to that user. We illustrate with another example for a User-Video SOM. Here we will extract:
uⱼ=└userID videosⱼ┘.
   An example of this vector will be
u₂₄=[24 120 22778 98 455 765]
   where [24] represents the userID and [120 22778 98 455 765] represents the list of songIDs or videoIDs.

Improvement of the extracted data means eliminating bad data. This includes profiles that have no data pertaining to the content vector. In addition, users with very few elements in the content vector will be eliminated. Exclusion of bad data is needed so that the trained SOM does not represent useless information. The procedures for filtering are:

1. The administrator extracts required data from the raw data in the form of a .txt or .csv file.
2. The filtering program reads the file and starts filtering the raw data.
3. Once the filtering process is completed, the program outputs a .txt or .csv file of the filtered data.
4. The improved extracted data is now ready for input to the training process.

A suitable self-organizing mapping theorem is applied (as conventionally known) to train the maps. The maps are trained given the filtered data provided in the previous process. From here we form a lemma:

Lemma: Given a X-Y filtered data pair, we can build a X-Y SOM and a Y-X SOM simultaneously.

Hence for a user-song filtered data pair, we train two SOM maps, namely a User-Song SOM and a Song-User SOM. The User-Song SOM clusters similar users based on content and the Song-User SOM clusters similar songs based on users selection.

The User-Song SOM is trained and maintained using the user-song vector:
uⱼ=└userID songsⱼ┘.

The Song-User SOM is trained and maintained using the song-user vector:
sₖ=[songID usersₖ].
   Training is unsupervised and automated. The end result in each case is a special-purpose SOM map that has been topographically organized.

The trained data is saved as a .txt or .csv file in the following format:
[node-index node-coordinates node-weight]
   where node-index presents the enumerated index of the node, node-coordinates represents the 2D position of the node on the map and node-weight is the associated weight of the node. An example is:
[411 3 5 0.1 0.5 0.3]
   where [411] is the index, [3 5] are the coordinates and [0.1 0.5 0.3] are the weights. The procedures for training are:
   1. The administrator extracts a .txt or .csv file of user or song profile vectors and executes a stand-alone training program.
   2. The program reads the file and starts training the map (User-Song SOM or Song-User SOM).
   3. Once the training is completed, the training program outputs a .txt or .csv file of the trained map.
   4. The SOM maps are now ready for recommendation and analysis by the software agents (SA).

The multi-SOM recommending system employs the cooperative use of multiple special-purpose SOMs created by the system, i.e., in this example, the User-Song SOM and Song-User SOM. Each has a given special-purpose that may be applied to corresponding search applications. For example, the User-Song SOM can have the following applications: (1) recommend other similar users; (2) reveal hidden patterns in artists' separations and similarities, ie. mapping of artists strengths; and (3) identify user demographic or geographic information favoring a given artist.

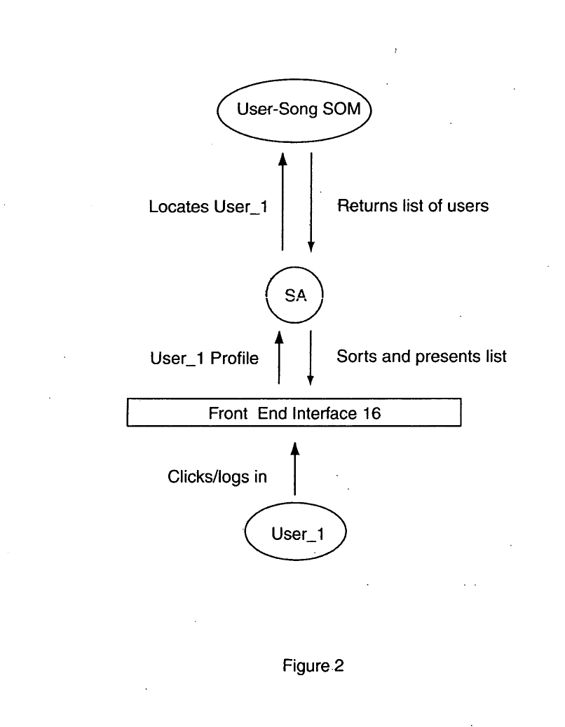

For recommending other similar users in response to query from a user to the Front End Interface 16, a software agent SA is assigned for delivering information between the user and the appropriate SOM(s) in response to a recommendation query, as illustrated in FIG. 2. For a query for recommending other similar users, the procedures are:

1. A query user clicks on a button or transmits a message into the Front End Interface 16 to request a list of similar users.
2. A software agent SA will extract the user's current content and sends over to the servers supporting the recommendation system.
3. This agent SA will match the user's content and locate a position on the User-Song SOM.
4. A list of similar users will be generated and produced on the front-end webpage for the query user.

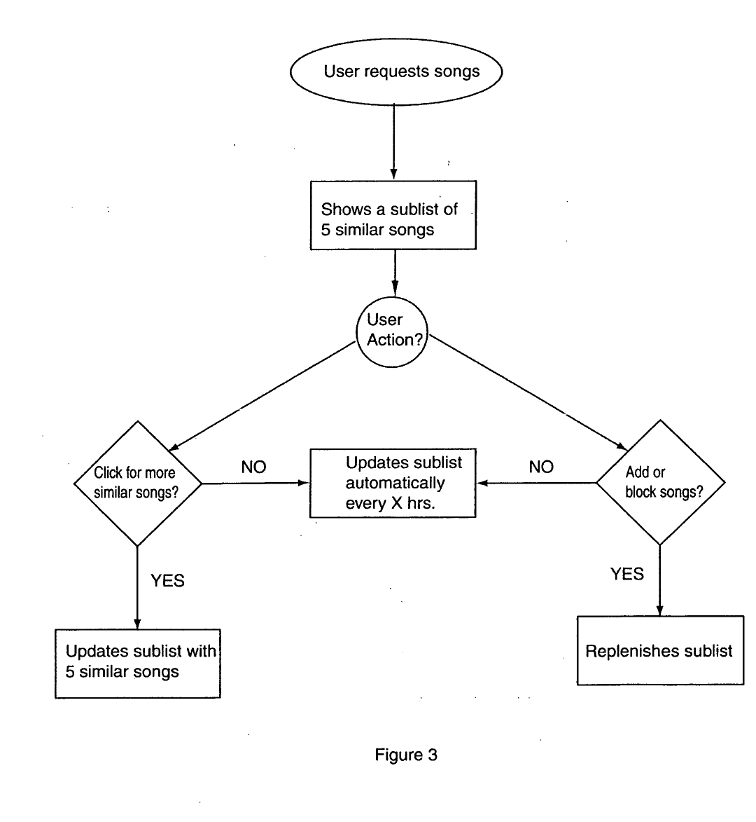

The resulting recommendation list can include many similar users on the order of hundreds. But the final presentation on the front-end web page may only show a small subset of this list, for example a sublist of four to six users. The query user can then follow up with whatever options are offered, for example, to click for an updated sublist or to block or add an user from this sublist, as illustrated in FIG. 3.

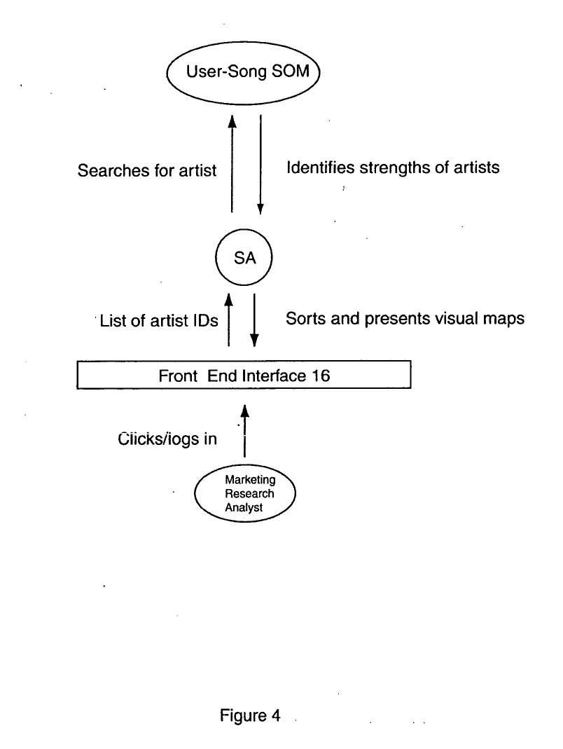

For revealing hidden patterns, such as in response to a user query for marketing analysis, optimizing advertisement and/or banner placements, a software agent is assigned by the Front End Interface for delivering the information between the front-end and the back-end, as illustrated in FIG. 4. The procedures for a query for revealing hidden patterns are:

1. The query user logs in to the front end GUI, selects a list of artists' names and clicks on a button to submit the request.
2. The software agent SA maps the list of artists and produces a matrix of 2-dimensional visual maps illustrating the strength of each artist.
3. The query user can use the maps to study and identify trends.

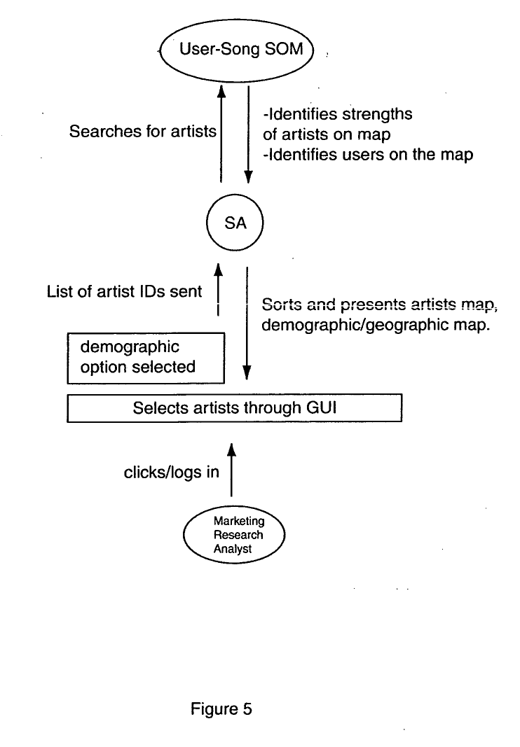

For identifying user demographic or geographic information, the procedures builds on the previous feature, running in parallel to the previous procedures. It can be used for marketing analysis and optimizing advertisement or banner placements. A software agent SA is assigned for delivering information between the front-end and the back-end, as illustrated in FIG. 5. The procedures for a query to identify user demographic or geographic information are:

1. The query user logs in, inputs at least one artist name, selects appropriate user demographic information and clicks on a button to submit the request.
2. The software agent SA will compute the strengths of the given artist/s.
3. The software agent SA will identify all users in the User-Song SOM who listen to the artist/s and produce a demographic or geographic 2-dimensional visual map.
4. The query user can study and identify trends, such as for ad banner placements.

As a SOM created for a special-purpose, the Song-User SOM can have the following applications:

1. Recommend other similar songs.
2. Identify users surrounding a given song.

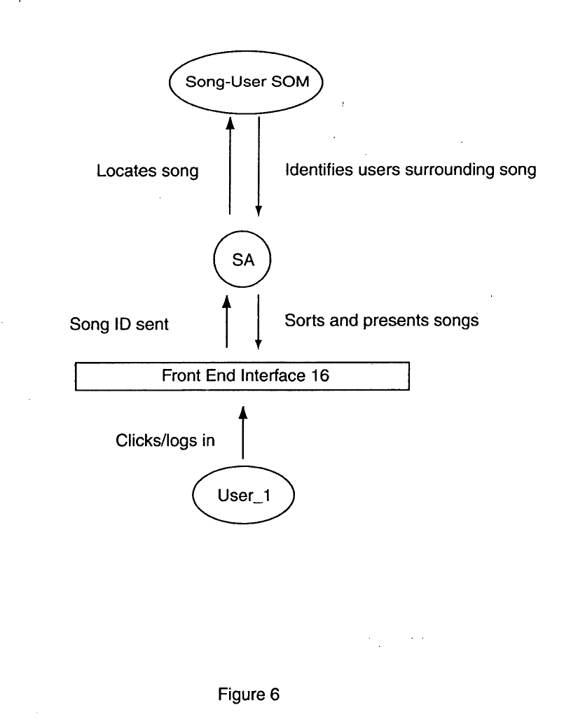

For recommending other similar songs, a song-recommendation software agent SA is assigned for delivering information between the front-end and the back-end, as illustrated in FIG. 6. The procedures for recommending other similar songs are:

1. The query user clicks on a button on, or transmits a message to, the Front End Interface 16 to request a list of songs.
2. A software agent SA will extract the user's current songs and sends over to the back-end servers.
3. The agent SA will match each song in list and locate its position in the Song-User SOM.
4. The neighboring songs of each located song will be identified.
5. A list of songs will be generated and produced through the Front End Interface 16 for the query user.

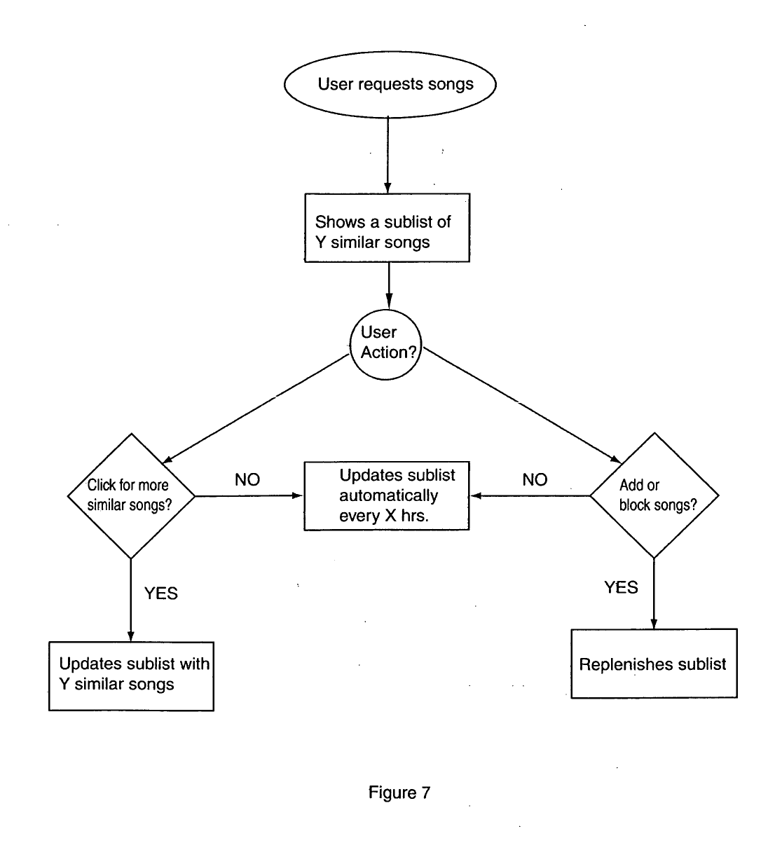

The query user can then follow up with whatever options are offered, for example, to click for an updated sublist or to select or block a song from this sublist, as illustrated in FIG. 7.

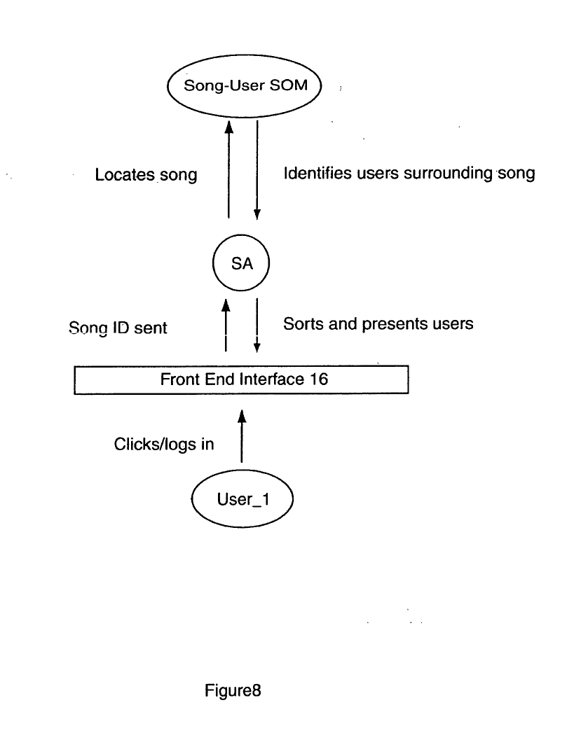

For identifying users surrounding a given song, a recommendation software agent SA is assigned for delivering the information between the front-end and the back-end, as illustrated in FIG. 8. The procedures for identifying users surrounding a given song are:

1. The query user selects at least one song or a list of songs, clicks on a button on, or transmits a message to, the front-end and submits a request for users who have the same songs.
2. A software agent SA sends the song/s to the back-end servers.
3. The agent SA will match each song in list and locate its position in the Song-User SOM.
4. A list of unique users having similar songs will be identified.
5. A list of users will be generated and produced on the front-end webpage for the query user.

### Structure of Software Agent

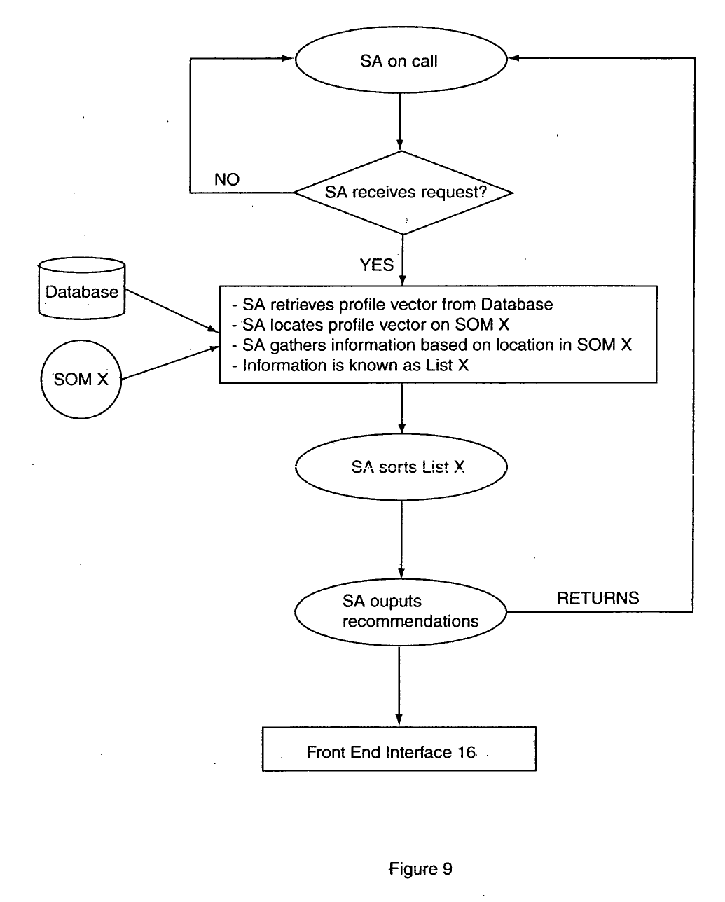

Information processing and recommendation in response to user queries to the Front End Interface is enabled by one or more software agents SA assigned by the User Interface to process a user query. An agent's primary job is to process an input data set and produce an output data set. The SA will also retrieve data from the trained SOMs and from the system database. The SA essentially runs on a set of software algorithms and can be deployed in a web application environment, accessed via user interfaces delivered by web servers. The procedures executed by a typical SA is illustrated in FIG. 9:

1. The SA is in a on-call state waiting for an request.
2. Once a request is received, the SA looks up on the database to retrieve the profile vector associated with the request. Depending on the request, the profile vector may include either the demographics, psychographics and/or content information.
3. The SA matches up the profile vector on SOM X and returns a list of related information known as List X.
4. The SA sorts List X and outputs the results.
5. The SA returns to the on-call state.

### Usage of Dual SOMs

As described above for the Filtering and Training processes, different special-purpose SOMs can be created depending on how we extract data. For example, if we want to evaluate a correlation between age, gender, country/state/city, and songs, then the following filtered data pair may be used: user-song, user-demography. Two SOMs will be trained using data entries of the filtered data pair, namely a User-Song SOM and a User-Demography SOM. The User-Demography SOM is trained using the vector:
uⱼ=└userID demoⱼ┘.
   A software agent is assigned to perform the task of retrieving information cooperatively between the two SOMs. The advantages of using two SOMs together include:
   1. Understanding and analyzing how the users' demographic and content data evolved over time.
   2. Allowing users to search similar content or other users by demographic data or content data efficiently.
   3. Keeping separate but loosely coupled records of highly dynamic data (eg users' behaviors) and pseudo-static data (eg users' gender, country etc).
   4. Eliminating the costly computational and data management necessity to train a single large SOM.
   5. In creating two SOMs. we are able to form new analysis/recommendation “pathways” through the data by forming new combinations between the SOMs.
   6. Assisting the marketing research analyst in visualizing demographic and content data simultaneously.

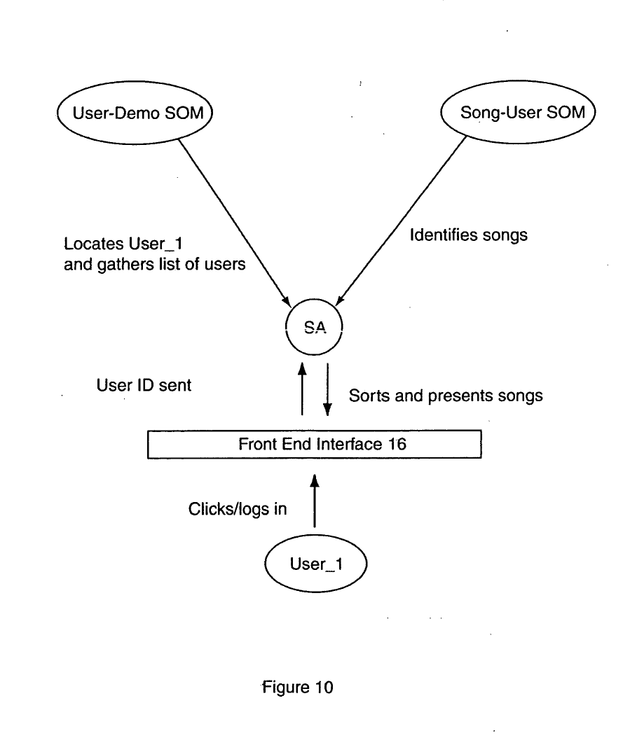

The use of the dual SOMs, User-Song SOM and User-Demography SOM, can be illustrated in the following examples using the procedure shown in FIG. 10:

### Dual-SOMs Example 1

1. A 20 year-old female user (User_1) residing in Spain wants to find out what other users around her age in Spain might like to listen to.
2. The software agent SA collects the userID and locates a list of users from the User-Demography SOM.
3. Using this list, the agent moves on to User-Song SOM to locate the users on the list and gathers their respective songs.
4. The list of songs are recommended to the user.

### Dual-SOMs Example 2

1. The same 20 year-old female user in Spain wants to find out what other users, similar to her music taste, around her age in Spain might like to listen.
2. The software agent collects the userID of this female user and locates a list of users of the same age and from Spain from the User-Demography SOM, called List A.
3. The software agent then locates this female user on the User-Song SOM to recommend a list of users with similar music taste, called List B.
4. The software agent cross-references Lists A and B to extract users common to both lists, called List (A∩B).

5. The list of songs belonging to users in List (A∩B) are recommended to the query user.

### Dual-SOMs Example 3

1. A query user would like to find out which artists do 25 year-old male users from Sao Paulo, Brazil listen to.
2. The software agent collects the queried cityID (e.g Sao Paulo), ageID (e.g. 25) and genderID (e.g. male), and locates a list of users from the User-Demography SOM.
3. Using this list, the agent moves on to User-Song SOM to locate the users and gathers their respective songs.
4. The list of artists are presented to the query user.

### Dual-SOMs Example 4

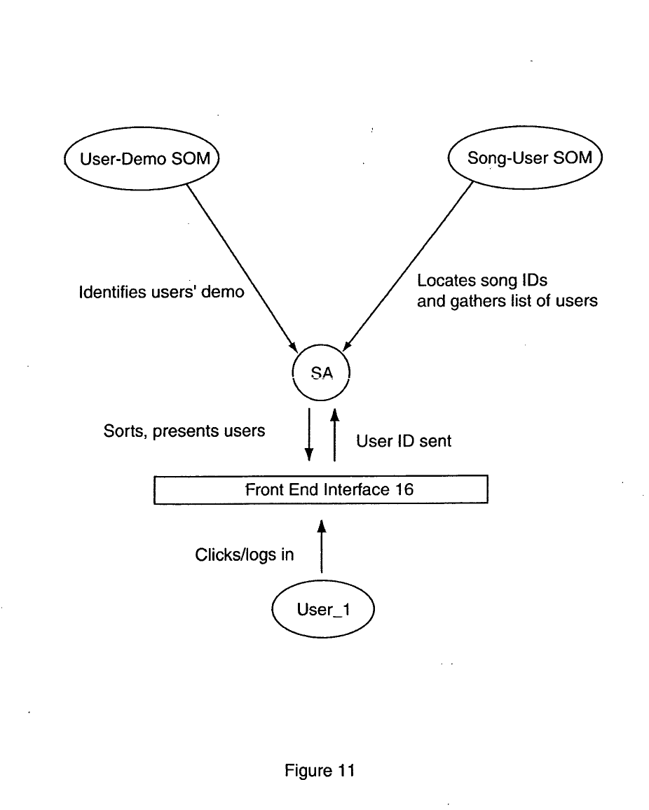

The use of other dual SOMs, a Song-User SOM and a User-Demography SOM, can be illustrated in the following example using the procedure shown in FIG. 11:

1. A query user would like to find out the demography data related to a song she has in her playlist.
2. The software agent collects the queried userID and songID, and locates a list of users surrounding that song from the Song-User SOM.
3. Using this list, the agent moves on to User-Demography SOM to locate the users and gathers their demographic data
4. The demographic data are presented to the user.

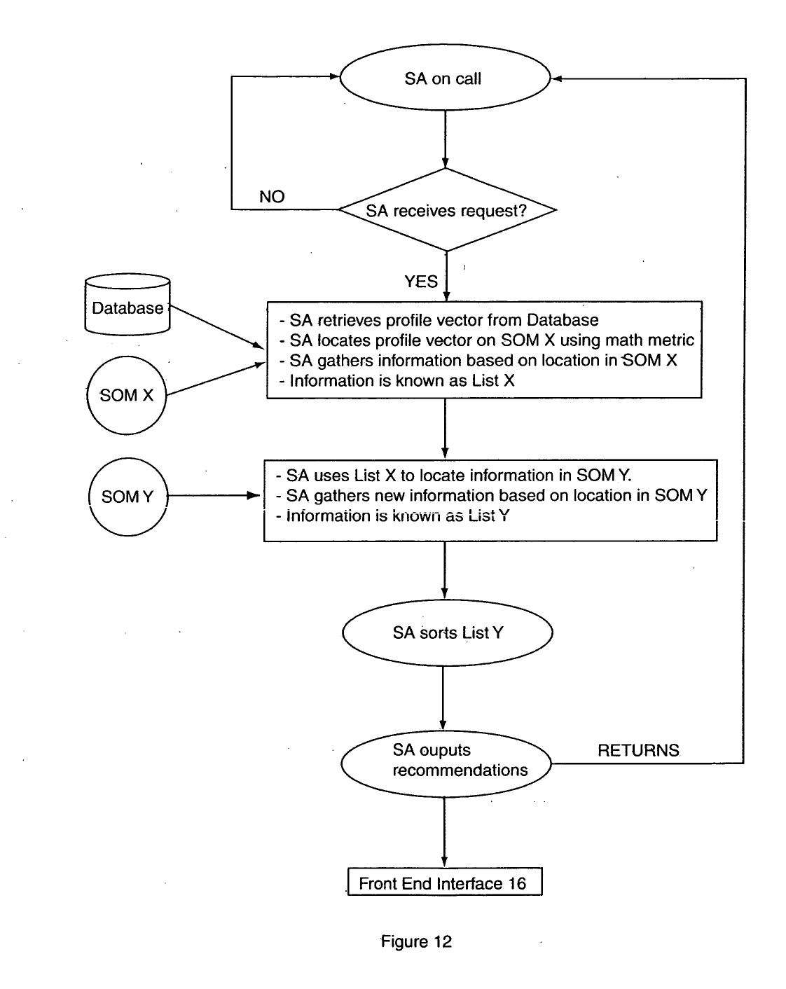

The procedures followed by the software agent SA structure for the Dual-SOMs in Example 4 are illustrated in FIG. 12, and explained as follows

1. The SA is in a on-call state waiting for an request.
2. Once a request is received, the SA looks up on the database to retrieve the profile vector associated with the request. Depending on the request, the profile vector may include either the demographics, psychographics and/or content information.
3. The SA matches up the profile vector on SOM X and returns a list of related information known as List X.
4. The SA presents List X to SOM Y and returns a list of related information known as List Y.
5. The SA sorts List Y and outputs the results.
6. The SA returns to the on-call state.

### Dual-SOM Example 5

In this example, we define a filtered data pair to identify banners that may be of interest to a user based upon data entries for what banners are clicked on or visited by users. The vector used to train this SOM is
uⱼ=└userID bannersⱼ┘.
   The procedures for identifying banners that may be of interest to a user are as follows:
   1. An administrator would like to present the relevant banners when a user logs on to the website.
   2. The software agent collects the userID and locates a list of users of similar demographic data from the User-Demography SOM.
   3. Using this list, the agent moves on to User-Banners SOM to locate the users and gathers a list of banners.
   4. The banners are presented sequentially to the user.

### Usage of Multiple SOMs

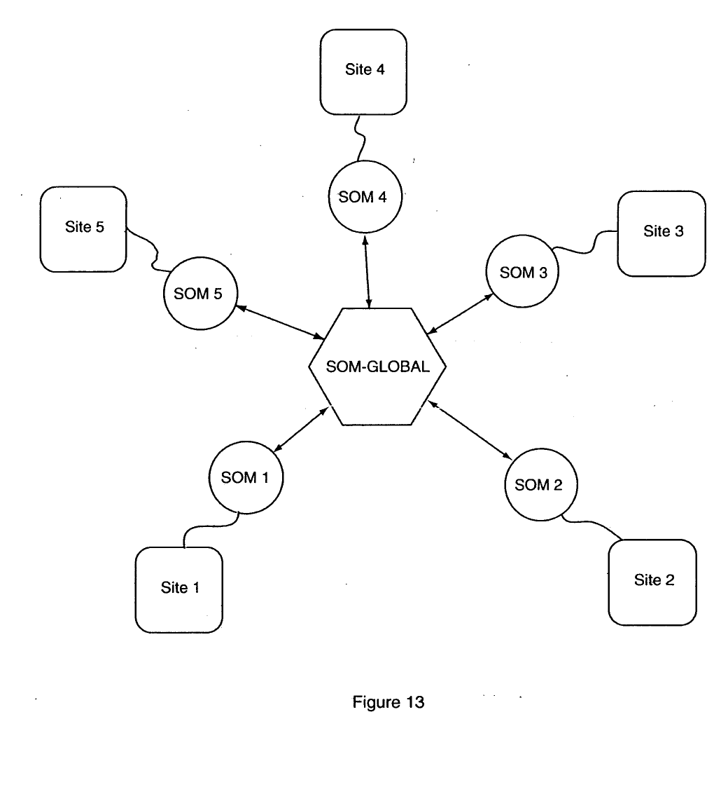

The above-described procedures for usage of dual SOMs can be expanded to enable the usage of multiple SOMs. Moreover, the multiple SOMs can be created or maintained at multiple websites. Each website may have access to raw data having data fields or attributes related to the characteristics of that website, and can create one or more SOMs using filtered data of correspondingly specified fields or attributes. As illustrated in FIG. 13, each website (Site 1, Site 2, Site 3, etc.) maintains at least one special-purpose SOM (SOM 1, SOM 2, SOM 3, etc.). The special-purpose SOMs of the different sites can then be accessed by software agents assigned by a SOM-Global website which serves as an interface for user queries.

The advantages of using multiple SOMs include:

1. Understanding and analyzing how users' demographic and content data evolved over time.
2. Allowing users to search similar content or other users by demographic data or content data efficiently across multiple websites.
3. Keeping separate but loosely coupled records of highly dynamic data (eg users' behaviors) and pseudo-static data (eg users' gender, country etc).
4. Eliminating the costly computational and data management necessity to train a single large SOM.
5. In creating a set of SOMs. we are able to form new analysis/recommendation “pathways” through the data by forming new combinations between the SOMs.
6. Assisting the marketing research analyst in visualizing demographic and content data from across different websites simultaneously.

In multi-SOM usage, several websites offering respective online services to users can be cooperatively harnessed together through the SOM-Global website. Each SOM website has its own database of users and content information. The SOM-Global site is where the user logs in and inputs requests for recommendations. The cooperative SOM sites are other sites that the SA will be retrieving recommendations from. Instead of training one single huge SOM that contains all information from across all the websites, multiple smaller SOMs maintained independently at different sites can be harnessed together using the strengths of the SOM for each site. In addition, a set of common variables can be extracted across all websites to train the SOM-Global site. The job of a SA in this case is to share and recommend information from one website to another.

For example, five websites may be selected which are offering the following services:
Site 1: Travel
Site 2: Restaurant Reviews
Site 3: Movie Reviews
Site 4: Social Networking
Site 5: Current News
   Users can access any or all five websites individually, and some users may registered at one or more websites. All users are required to provide basic demographic information requested when they register at a particular site. Each user will have a profile of the content that they have selected, read, reviewed, browsed etc. The format of the user profile may be as follows:
uⱼ(site_{K})=└userID demoⱼ psyⱼ contentⱼ┘
   with a slight index modification to include which site the user belongs to, where Kε[1,2,3,4,5] in this example. To train an individual SOM K for a particular website, data entries are extracted following from the user profiles at the website:
uⱼ(site_{K})=└userID intⱼ┘
   To train the SOM-Global, data entries are extracted from all users across all websites:
uⱼ(site_{K})=└userID demoⱼ┘

To illustrate, a User-Content SOM can be trained for each website and a global User-Demographic SOM can be trained for the SOM-Global site. Users can query the SOM-Global site to recommend interesting contents from a user of one website to another user of another website. The unifying factor for this to function properly is the set of all users' demographic information. The assumption made here is that users with similar demographics should enjoy similar news, music, movies, restaurants and travel destinations. A user may be requesting recommendations explicitly and implicitly. The former relates to requiring user to process a request for a list of content such as songs, videos, friends etc. The latter relates to banner placements and certain informational feeds that the user may have signed up during registration.

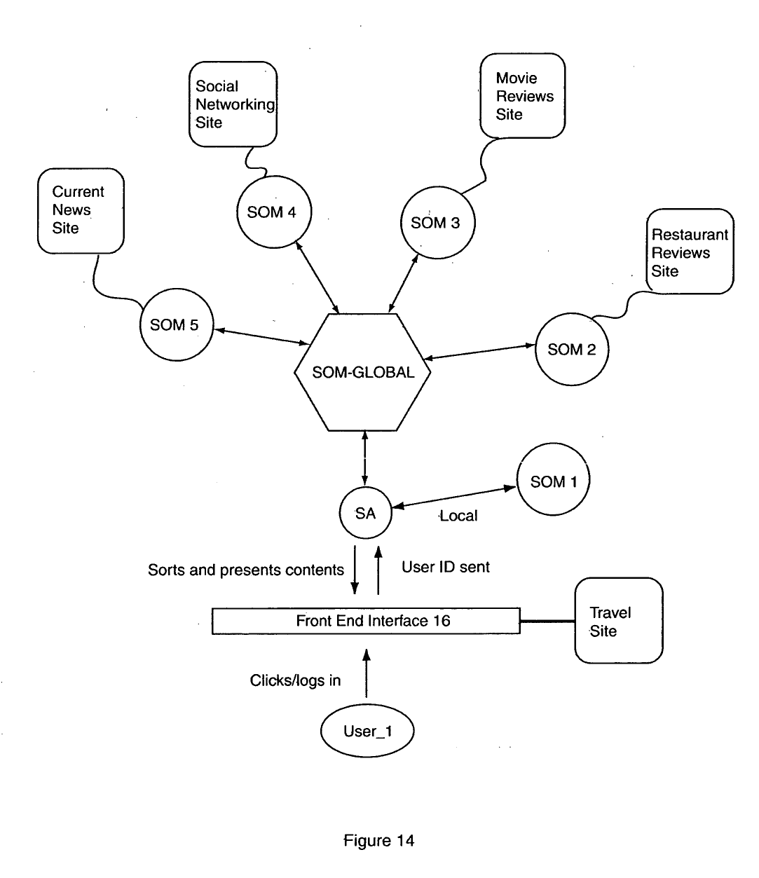

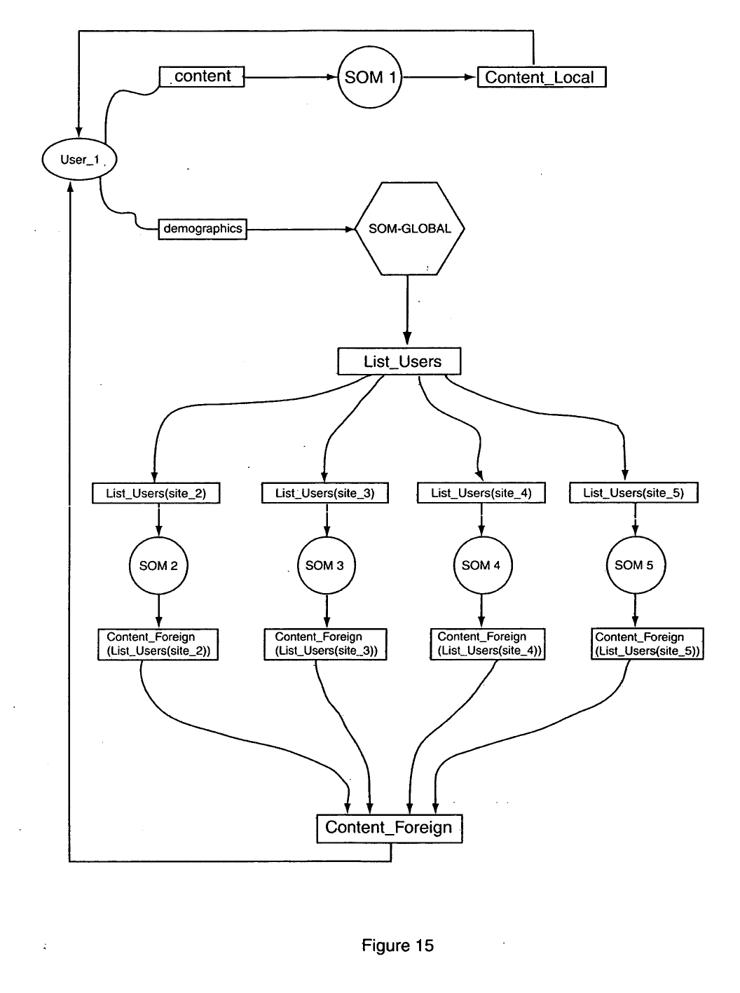

The procedures for an example of requesting recommendations from a local SOM website and foreign SOM websites are illustrated in FIGS. 14 and 15, as follows:

1. A user, User_1, logs into the Travel Site and requests recommendations for other travel destinations.
2. The SA collects the queried user profile and locates content using SOM 1 (local). This Content_Local is presented back to the user.
3. The SA then sends this user's demographic data to SOM-GLOBAL and collects a list of users, List_Users, with similar demographics data from SOM 2 through SOM 5 (foreign sites).
4. The SA locates these users based on the different foreign sites, eg List_Users (site₃) and gathers their respective contents, eg Content_Foreign(List_Users (site₃)).
5. The SA congregates, sorts and presents Content_Foreign to the user.

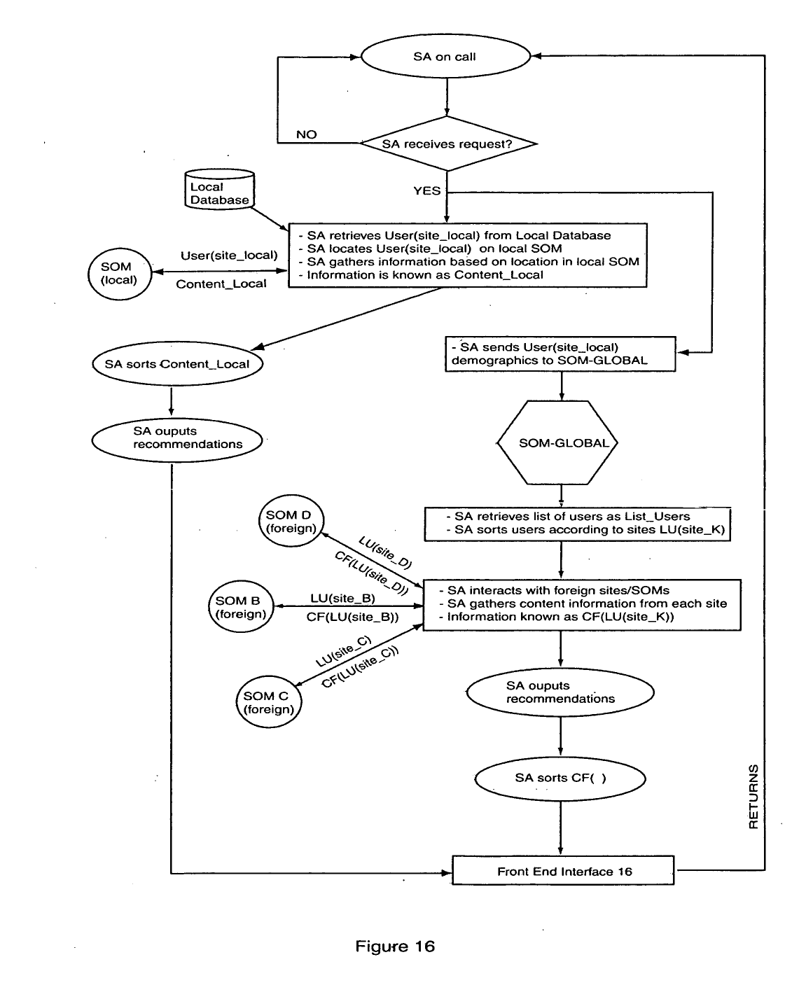

The procedures for the software agent SA in the above example of requesting recommendations from multiple sites with multiple SOMs are illustrated in FIG. 16, as follows:

1. The SA is in a on-call state waiting for a request.
2. Once a request is received, the SA looks up on the local site database to retrieve User (site_{local}) associated with the request. Depending on the request, User (site_{local}) may include either the demographics, psychographics and/or content information.
3. The SA matches up User (site_{local}) on local SOM and returns a list of related information known as Content_Local.
4. The SA concurrently sends the User (site_{local})'s demographic data to SOM-GLOBAL and collects a list of users with similar demographics data. This list is known as List_Users (or LU).
5. The SA sorts List_Users according to foreign SOMs as List_Users (site_{K}) or LU (site_{K}).
6. For each LU (site_{K}), the SA looks up the contents of the users from site_{K}. Content is stored as Content_Foreign(List_Users (site_{K})) or CF(LU (site_{K})).
7. The SA congregates CF(LU (site_{K})), ∀K: K≠Local, as CF (·).
8. The SA sorts and outputs CF (·).
9. The SA returns to the on-call state.

It is noted that it is entirely possible that LU (site_{K})={Ø} for some K. Assuming that LU=∪List_Users(site_{K}), ∀K: K≠Local., then CF (·) is in fact
∪CF(LU(site_{K})), ∀K: K≠Local.

### Computational Complexity Analysis

In understanding why a multiple-SOM training approach is more desirable than training a single huge SOM as the dimensionality of the input vectors increases, we apply computation complexity analysis, based on SOM mapping theory. As shown in Table I, let:

TABLE I

| | |
|---|---|
| N | number of data samples εZ⁺ |
| M | size of map (or number of nodes) εZ⁺ |
| d | dimension of each input profile vector εZ⁺ |
| I | number of iterations (or training steps) εZ⁺ |
| α, β | constants εR⁺ |

The size of the map is proportional to the dimension of the vector, M=αd. The number of iterations is proportional to the size of the map, I=βM. The above statements essentially imply that an input vector with a higher dimensionality will require more training steps on a map with more nodes. In this example, we can separate a user profile into two subsets, User-Demo and User-Content:
uⱼ=└userID demoⱼ┘
uⱼ=└userID contentⱼ┘
   where the former has a dimension of d₁ and latter a dimension of d₂. The overall user profile used to train a single User-Demo/Content SOM will take on the vector,
uⱼ=└userID demoⱼ contentⱼ┘
   where the dimension is d₁+d₂. To train the two SOMs, User-Demo and User-Content, the complexity is
O[d₁N²I₁M₁]+O[d₂N²I₂M₂]
[symbol] O[d₁N²βM₁M₁]+O[d₂N²βM₂M₂]
[symbol] O[d₁N²βα²d₁²]+O[d₂N²βα²d₂²]
[symbol] O[d₁³N²]+O[d₂³N²]
[symbol] O[max(d₁³N², d₂³N²)]
   To train the single SOM, User-Demo/Content, the complexity is
O[(d₁+d₂)N²I₁₂M₁₂]
[symbol] O[(d₁+d₂)N²βM₁₂M₁₂]
[symbol] O[(d₁+d₂)N²βα²(d₁+d₂)²]
[symbol] O[(d₁+d₂)³N²βα²]
[symbol] O[(d₁+d₂)³N²]
   Since intuitively d₁+d₂>max(d₁, d₂), therefore
O[(d₁+d₂)³N²]≧O[max(d₁³N², d₂³N²)].
   Hence it is computationally more complex to train a single SOM with a larger map and larger input dimensions.

In summary, the system and method of the present invention provides for constructing a number of smaller, special-purpose SOMs from a SOM Database which can contain data entries that include a wide range of fields or attributes of user preferences. Multiple special-purpose SOMs are harnessed cooperatively together to provide recommendations to different types of user queries. The system thus can function more efficiently, and can utilize non-homogenous data of differing dimensionalities and/or from diverse sources to handle diverse types of queries from users.

It is to be understood that many modifications and variations may be devised given the above description of the principles of the invention. It is intended that all such modifications and variations be considered as within the spirit and scope of this invention, as defined in the following claims.

1. A method, operable on a computer system and associated database, for creating and using self-organizing maps (SOMs) based on user preference data provided for making recommendations of preferred items in response to queries to the computer system for recommendations, comprising:
maintaining a SOM Database containing user preference data entries that include a wide range of fields or attributes of user preferences;
creating a plurality of special-purpose SOMs by filtering from the SOM Database those user preference data entries having fields and attributes related to a respective special purpose of each special-purpose SOM;
training each respective special-purpose SOM with the respective, filtered user preference data entries; and
applying the plurality of trained special-purpose SOMs in coordination with each other to provide recommendations in response to queries based upon inter-cooperation of the special-purpose SOMs each trained with respective fields and attributes of user preferences related to its respective special purpose.

2. A method for creating and using self-organizing maps (SOMs) according to claim 1, wherein at least two SOMs are created and used together to provide recommendations in response to queries.

3. A method for creating and using self-organizing maps (SOMs) according to claim 2, adapted for song recommendation, wherein the at least two SOMs are selected from the group consisting of: a User-Demographic SOM; a User-Song SOM; and a Song-User SOM.

4. A method for creating and using self-organizing maps (SOMs) according to claim 2, adapted for song recommendation, wherein the SOM Database contains data entries for user preferences including one or more of the group consisting of: geographical data; personal/social data (gender, birth date, sexual orientation, ethnicity, religion, education, income level, profession, smoke/drink/food and language preferences); personal interest data (friends, favorites, blogs, music genres); song preferences; and band/artist preferences.

5. A method for creating and using self-organizing maps (SOMs) according to claim 1, wherein multiple SOMs are created and used together to provide recommendations in response to queries.

6. A method for creating and using self-organizing maps (SOMs) according to claim 5, wherein the multiple SOMs are created and maintained at multiple websites.

7. A method for creating and using self-organizing maps (SOMs) according to claim 6, wherein each of the multiple SOMs are maintained at a different website, respectively.

8. A method for creating and using self-organizing maps (SOMs) according to claim 6, wherein the multiple websites are harnessed through a SOM-Global website serving as a global interface for queries.

9. A method for creating and using self-organizing maps (SOMs) according to claim 8, wherein queries to the multiple SOMs are processed through a software agent assigned between the SOM-Global website serving as a global interface for queries and inter-cooperation of the special-purpose SOMs.

10. A method for creating and using self-organizing maps (SOMs) according to claim 1, wherein queries to the two or more special-purpose SOMs are processed through a software agent assigned between a front end interface for queries and the special-purpose SOMs.

11. A computerized system having an associated database operable for creating and using self-organizing maps (SOMs) based on user preference data provided for making recommendations of preferred items in response to queries to the computer system for recommendations, comprising:
a SOM Database containing user preference data entries that include a wide range of fields or attributes of user preferences;
a plurality of special-purpose SOMs each respectively generated by filtering from the SOM Database those user preference data entries having fields and attributes related to a respective special purpose of each special-purpose SOM; and
a front end interface and software agent assigned therewith for applying two or more of the trained special-purpose SOMs to provide recommendations of preferred items in response to queries,
wherein each respective special-purpose SOM is trained with respective, filtered user preference data entries in accordance with its respective special purpose, and wherein the trained special-purpose SOMs are operated in inter-cooperation with each other based upon each being trained with respective fields and attributes of user preferences related to its respective special purpose.

12. A system for creating and using self-organizing maps (SOMs) according to claim 11, wherein at least two SOMs are created and used together to provide recommendations in response to queries.

13. A system for creating and using self-organizing maps (SOMs) according to claim 12, adapted for song recommendation, wherein the at least two SOMs are selected from the group consisting of: a User-Demographic SOM; a User-Song SOM; and a Song-User SOM.

14. A system for creating and using self-organizing maps (SOMs) according to claim 12, adapted for song recommendation, wherein the SOM Database contains data entries for user preferences including one or more of the group consisting of: geographical data; personal/social data (gender, birth date, sexual orientation, ethnicity, religion, education, income level, profession, smoke/drink/food and language preferences); personal interest data (friends, favorites, blogs, music genres); song preferences; and band/artist preferences.

15. A system for creating and using self-organizing maps (SOMs) according to claim 11, wherein multiple SOMs are created and used together to provide recommendations in response to queries.

16. A system for creating and using self-organizing maps (SOMs) according to claim 15, wherein the multiple SOMs are created and maintained at multiple websites.

17. A system for creating and using self-organizing maps (SOMs) according to claim 16, wherein each of the multiple SOMs are maintained at a different website, respectively.

18. A system for creating and using self-organizing maps (SOMs) according to claim 16, wherein the multiple websites are harnessed through a SOM-Global website serving as a global interface for queries.

19. A system for creating and using self-organizing maps (SOMs) according to claim 18, wherein queries to the multiple SOMs are processed through a software agent assigned between the SOM-Global website serving as a global interface for queries and the special-purpose SOMs.

20. A system for creating and using self-organizing maps (SOMs) according to claim 11, wherein queries to the two or more special-purpose SOMs are processed through a software agent assigned to act between a front end interface for queries and the special-purpose SOMs.
